(19) United States
(12) Patent Application Publication
(10) Pub. No.: US 2014/0183987 A1
(43) Pub. Date: Jul. 3, 2014

(54) SPINDLE MOTOR AND MOTOR UNIT

(71) Applicant: Nidec Corporation, Kyoto (JP)

(72) Inventors: Yoichi SEKII, Kyoto (JP); Tsuchitsugu WATANABE, Kyoto (JP); Junichi HASHIMOTO, Kyoto (JP)

(73) Assignee: NIDEC CORPORATION, Kyoto (JP)

(21) Appl. No.: 14/036,333

(22) Filed: Sep. 25, 2013

(30) Foreign Application Priority Data
Dec. 29, 2012 (JP) 2012-289209

(51) Int. Cl. H02K 7/08; H02K 7/00

(52) U.S. Cl. CPC H02K 7/083; H02K 7/003
USPC 310/52

(57) ABSTRACT

A motor unit includes a rotating portion and a stationary portion. The rotating portion includes a shaft, a rotor hub, and a rotor magnet. The rotor hub includes a top plate portion and a cylindrical portion. The stationary portion includes a sleeve and an armature. The armature is arranged radially opposite the rotor magnet. A lubricating fluid is arranged between an outer circumferential surface of the shaft and an inner circumferential surface of the sleeve with at least one of the outer circumferential surface of the shaft and the inner circumferential surface of the sleeve including an upper radial dynamic pressure groove array and a lower radial dynamic pressure groove array. An axial position of a center of gravity of the rotating portion is arranged above an axial position of the lower radial dynamic pressure groove array.

### BACKGROUND OF THE INVENTION

1. Field of the Invention

The present invention relates to a spindle motor and a motor unit arranged to rotate a plurality of disks.

2. Description of the Related Art

In a DLP (Digital Light Processing) single-chip projector, light emitted from a light source passes through a rotating color wheel. The light passing through the color wheel is converted into light in one of RGB bands, and the resulting light impinges on a digital micromirror device. Then, light reflected from the digital micromirror device is directed to a predetermined screen and an image is displayed thereon. In such a projector, a motor designed to rotate the color wheel is used. In a conventional motor designed to rotate the color wheel, a rotating portion, to which the color wheel is attached, is rotatably supported by a ball bearing or a sleeve bearing. Such a conventional motor designed to rotate the color wheel is described, for example, in JP-A 2005-278309.

In recent years, there has been a demand for motors designed to rotate color wheels to be able to rotate the color wheels with higher accuracy. As described above, the light emitted from the light source passes through the rotating color wheel. If the rotating color wheel is inclined at this time, the light passing through the color wheel is converted into light in a band different from a desired band. If the light in the band different from the desired band is reflected by the digital micromirror device, light in a color different from a desired color is displayed on the screen. This leads to a deterioration in color and brightness of the image displayed on the screen. Accordingly, there has been a demand for more accurate rotation of the color wheel to improve the color and brightness of the image.

Ball bearings or sleeve bearings are used in conventional motors designed to rotate color wheels as described above. However, these bearings tend to be worn easily by rotation, and long-term use thereof results in a deterioration in rotational accuracy.

There has accordingly been a demand for a motor designed to rotate the color wheel, the motor being capable of rotating the color wheel with high accuracy for a long period of time.

### SUMMARY OF THE INVENTION

According to a preferred embodiment of the present invention, there is provided a motor unit arranged to rotate a plurality of disks. The motor unit is arranged to rotate the plurality of disks about a central axis extending in a vertical direction. The motor unit includes a rotating portion arranged to rotate about the central axis, and a stationary portion arranged to support the rotating portion. The rotating portion includes a shaft, a rotor hub, and a rotor magnet. The rotor hub includes a top plate portion and a cylindrical portion. The top plate portion is disk-shaped or substantially disk-shaped and arranged to extend radially outward from an upper portion of the shaft. The cylindrical portion is cylindrical or substantially cylindrical and arranged to extend in an axial direction from an outer edge portion of the top plate portion. The rotor magnet is arranged on the rotor hub. The stationary portion includes a sleeve and an armature. The sleeve is cylindrical or substantially cylindrical and includes a bearing hole. The armature is arranged radially opposite the rotor magnet. The shaft is accommodated in the bearing hole. A lubricating fluid is arranged between an outer circumferential surface of the shaft and an inner circumferential surface of the sleeve. At least one of the outer circumferential surface of the shaft and the inner circumferential surface of the sleeve includes an upper radial dynamic pressure groove array and a lower radial dynamic pressure groove array. Each of the upper and lower radial dynamic pressure groove arrays is arranged to generate a dynamic pressure in the lubricating fluid. The lower radial dynamic pressure groove array is arranged below the upper radial dynamic pressure groove array. The rotor hub includes an upper disk mounting portion and a lower disk mounting portion. The lower disk mounting portion is arranged axially below the upper disk mounting portion. The lower disk mounting portion is arranged at a level lower than a level of the lower radial dynamic pressure groove array. An axial position of a center of gravity of the rotating portion is arranged above an axial position of the lower radial dynamic pressure groove array.

According to another preferred embodiment of the present invention, a spindle motor is provided. The spindle motor includes a rotating portion arranged to rotate about a central axis extending in a vertical direction, and a stationary portion arranged to support the rotating portion. The rotating portion includes a shaft, a rotor hub, and a rotor magnet. The rotor hub includes a top plate portion and a cylindrical portion. The top plate portion is disk-shaped or substantially disk-shaped and arranged to extend radially outward from an upper portion of the shaft. The cylindrical portion is cylindrical or substantially cylindrical and arranged to extend in an axial direction from an outer edge portion of the top plate portion. The rotor magnet is arranged on the rotor hub. The stationary portion includes a sleeve, an armature, and a base portion. The sleeve is cylindrical or substantially cylindrical and includes a bearing hole. The armature is arranged radially opposite the rotor magnet. The base portion includes a bearing holding portion arranged to hold the sleeve. The rotor hub includes a recessed portion having a downward opening, and arranged to be coaxial with the central axis. An inner circumferential surface of the recessed portion includes a first inner circumferential surface and a second inner circumferential surface. The first inner circumferential surface is arranged opposite to an outer circumferential surface of the sleeve with a first minute gap intervening therebetween. The second inner circumferential surface is arranged radially outward of the first inner circumferential surface, and arranged opposite to an outer circumferential surface of the bearing holding portion with a second minute gap intervening therebetween. The shaft is accommodated in the bearing hole. A lubricating fluid is arranged between an outer circumferential surface of the shaft and an inner circumferential surface of the sleeve. A liquid surface of the lubricating fluid is arranged between the shaft and the sleeve. At least one of the outer circumferential surface of the shaft and the inner circumferential surface of the sleeve includes a plurality of radial dynamic pressure groove arrays. Each of the radial dynamic pressure groove arrays is arranged to generate a dynamic pressure in the lubricating fluid. The liquid surface of the lubricating fluid, the first minute gap, and the second minute gap are arranged consecutively in order from radially inward to radially outward.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a motor according to a preferred embodiment of the present invention.

FIG. 2 is a bottom view of the motor according to a preferred embodiment of the present invention.

FIG. 3 is a cross-sectional view illustrating a portion of FIG. 2.

FIG. 4 is a cross-sectional view of a bearing used in the motor according to a preferred embodiment of the present invention.

FIG. 5 is a cross-sectional view illustrating a portion of the motor according to a preferred embodiment of the present invention.

FIG. 6 is a cross-sectional view of a motor according to a modification of a preferred embodiment of the present invention.

### DETAILED DESCRIPTION OF THE PREFERRED EMBODIMENTS

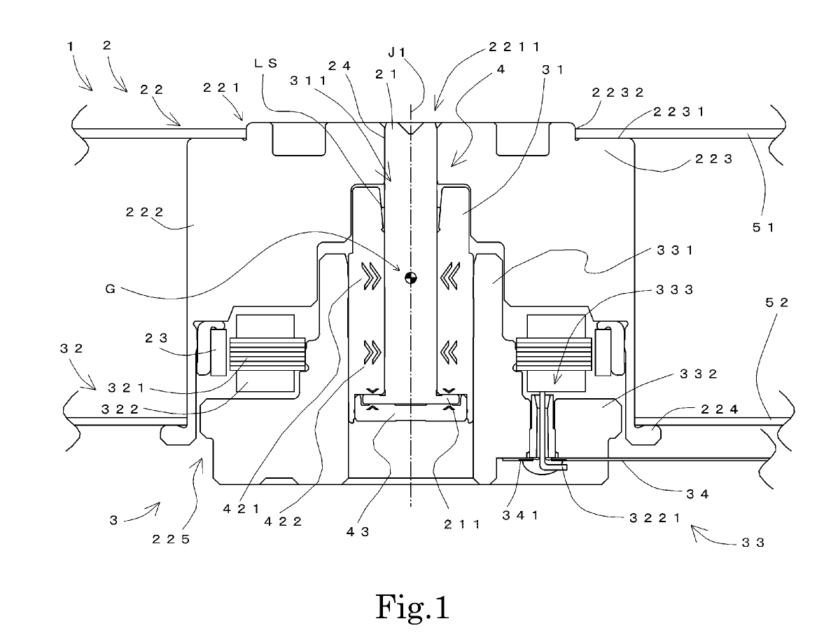

It is assumed herein that a vertical direction is defined as a direction in which a central axis of a motor extends, and that an upper side and a lower side along the central axis in FIG. 1 are referred to simply as an upper side and a lower side, respectively. It should be noted, however, that the above definitions of the vertical direction and the upper and lower sides should not be construed to restrict relative positions or directions of different members or portions when the motor is actually installed in a device.

Also note that a direction parallel or substantially parallel to the central axis is referred to by the term “axial direction”, “axial”, or “axially”, that directions perpendicular or substantially perpendicular to the central axis are simply referred to by the term “radial direction”, “radial”, or “radially”, and that a circumferential direction about the central axis is simply referred to by the term “circumferential direction”, “circumferential”, or “circumferentially”.

Note that the terms “axial direction”, “axial”, and “axially” as used herein refer to not only a direction exactly parallel to the central axis but also directions pointing in so nearly the same direction as the central axis that practicability of the present invention may not be impaired. Also note that the terms “radial direction”, “radial”, and “radially” as used herein refer to not only directions exactly perpendicular to the central axis but also directions pointing in so nearly the same direction as any perpendicular to the central axis that the practicability of the present invention may not be impaired.

FIG. 1 is a cross-sectional view of a spindle motor 1 according to a preferred embodiment of the present invention. The spindle motor 1 will be hereinafter referred to simply as the motor 1. The motor 1 is preferably used in a DLP projector or the like, and is arranged to rotate a plurality of disks. In other words, the disks are caused by the motor 1 to rotate about a central axis J1 extending in a vertical direction. The motor 1 includes a rotating portion 2 and a stationary portion 3. The rotating portion 2 is arranged to rotate about the central axis J1. The stationary portion 3 is arranged to support the rotating portion 2.

The rotating portion 2 preferably includes a shaft 21, a rotor hub 22, and a magnet 23. The rotor hub 22 includes a top plate portion 221 and a cylindrical portion 222. The top plate portion 221 is in the shape of a disk, and is arranged to extend radially outward from an upper portion of the shaft 21. The cylindrical portion 222 is in the shape of a cylinder, and is arranged to extend in an axial direction from an outer edge portion of the top plate portion 221. The rotor magnet 23 is arranged on the rotor hub 22. In FIG. 1, the rotor magnet 23 is arranged on an inner circumferential surface of the cylindrical portion 222 of the rotor hub 22, that is, the motor 1 is preferably an outer-rotor motor. Note, however, that the rotor magnet 23 may be arranged on an outer circumferential surface of the cylindrical portion 222 of the rotor hub 22, that is, the motor 1 may alternatively be an inner-rotor motor.

Referring to FIG. 1, the top plate portion 221 of the rotor hub 22 includes a shaft insert hole 2211. The upper portion of the shaft 21 is preferably, for example, press fitted into and thus fixed in the shaft insert hole 221. Alternatively, the upper portion of the shaft 21 may be inserted or press fitted into and thus fixed in the shaft insert hole 221 with an adhesive arranged between an outer circumferential surface of the upper portion of the shaft 21 and an inner circumferential surface of the top plate portion 221. Accordingly, there is a junction 24 of the shaft 21 and the rotor hub 22 between the outer circumferential surface of the upper portion of the shaft and the inner circumferential surface of the top plate portion 221.

The rotor hub 22 preferably includes an upper disk mounting portion 223 and a lower disk mounting portion 224. An upper disk 51 is mounted on the upper disk mounting portion 223. A lower disk 52 is mounted on the lower disk mounting portion 224. The lower disk mounting portion 224 is arranged below the upper disk mounting portion 223. The upper disk mounting portion 223 preferably includes an annular surface 2231 and a cylindrical surface 2232. The annular surface 2231 is arranged at an outer edge of the top plate portion 221. The cylindrical surface 2232 is arranged radially inward of the annular surface 2231. The axial position of the annular surface 2231 is arranged below that of the cylindrical surface 2232. The lower disk mounting portion 224 is arranged to extend radially outward from a lower portion of the cylindrical portion 222. The cylindrical surface 2232 of the upper disk mounting portion 223 is arranged to have a diameter smaller than the outside diameter of the cylindrical portion 222. Note that the upper disk 51 may be mounted on the upper disk mounting portion 223 through, for example, an adhesive or the like, or may be mounted on the upper disk mounting portion 223 through a clamper or the like. Also note that the lower disk 52 may be mounted on the lower disk mounting portion 224 through the adhesive or the like, or may be mounted on the lower disk mounting portion 224 through a clamper or the like.

The stationary portion 3 preferably includes a sleeve 31, an armature 32, a base portion 33, and a circuit board 34. The sleeve 31 is in the shape of a cylinder, and includes a bearing hole 311. The shaft 21 is accommodated in the bearing hole 311. The armature 32 is arranged below the top plate portion 221, and is arranged radially opposite the rotor magnet 23. Each of the sleeve 31 and the armature 32 is supported by the base portion 33. The base portion 33 preferably includes a bearing holding portion 331, a flat plate portion 332, and through holes 333. The bearing holding portion 331 is in the shape of a cylinder, and is arranged to hold the sleeve 31. The flat plate portion 332 is arranged to extend radially outward from a lower portion of the bearing holding portion 331. Each through hole 333 is arranged to pass completely through the flat plate portion 332 in the axial direction. The circuit board 34 is arranged on a lower surface of the base portion 33.

The armature 32 preferably includes a stator core 321 and a plurality of coils 322. The stator core 321 is, for example, defined by laminated steel sheets. The laminated steel sheets are obtained by placing a plurality of electromagnetic steel sheets (e.g., silicon steel sheets) one upon another in the axial direction. The stator core 321 includes a plurality of teeth. The teeth are preferably arranged at regular or substantially regular intervals in a circumferential direction.

Each coil 322 is preferably defined by at least one conducting wire 3221 being wound around a corresponding one of the teeth. The motor 1 according to the present preferred embodiment is preferably a three-phase motor. Therefore, the coils 322 are defined by three conducting wires 3221 each of which is used to supply a separate one of three phase electrical currents. An end portion of each of the conducting wires 3221 is drawn out downwardly of a lower surface of the flat plate portion 332 from above an upper surface of the flat plate portion 332 through a corresponding one of the through holes 333. Further, the end portion of each conducting wire 3221 is electrically connected to the circuit board 34. Note that “to be electrically connected” means “to be in electrical continuity”. The conducting wires 3221 include a common wire and the aforementioned three conducting wires used to supply the three phase currents.

An insulating member is preferably arranged in each through hole 333. The insulating member is arranged to prevent a contact between the base portion 33 and each conducting wire 3221. Each conducting wire 3221 is thus prevented from being short-circuited.

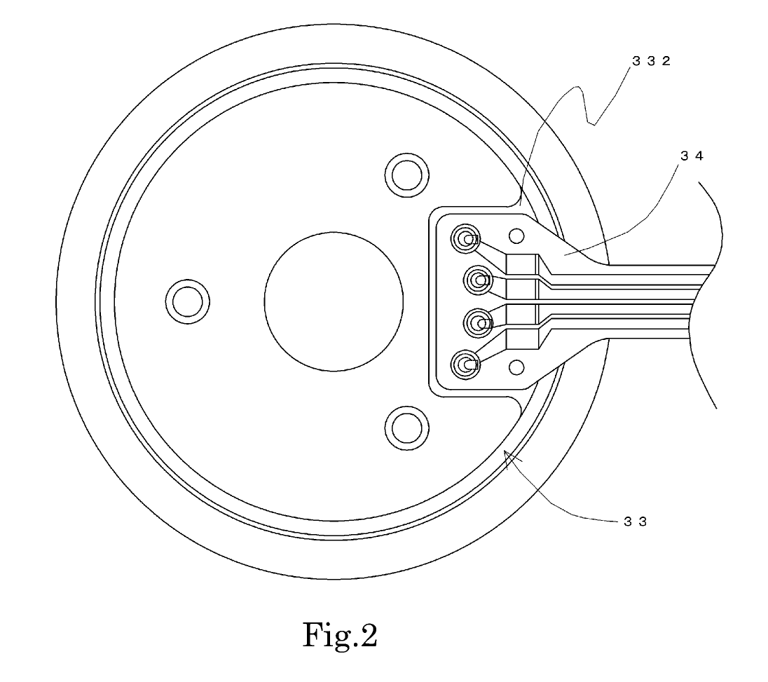

FIG. 2 is a bottom view of the motor 1. The circuit board 34 is arranged on the lower surface of the base portion 33. More specifically, the circuit board 34 is arranged on the lower surface of the flat plate portion 332, and is arranged to extend radially outward therefrom. The circuit board 34 is connected to an external power supply.

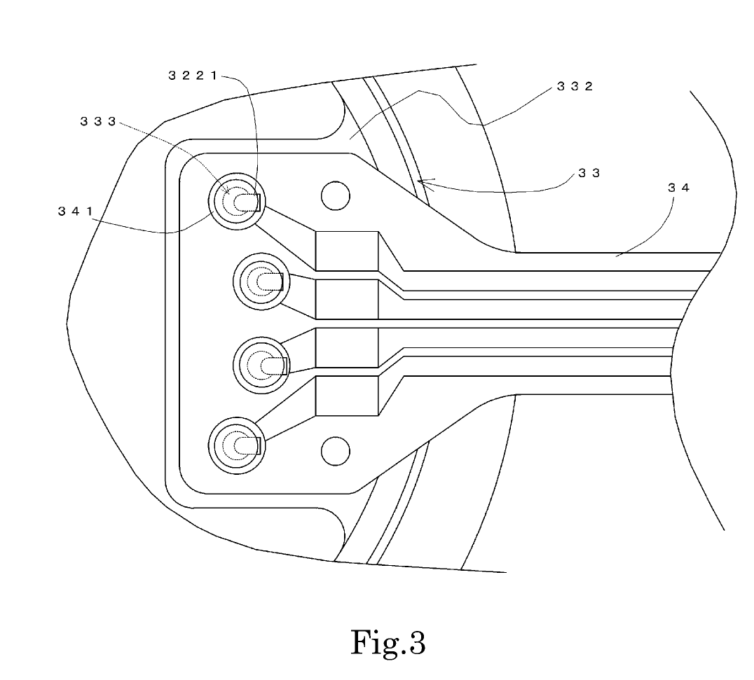

FIG. 3 is a diagram illustrating a portion of FIG. 2 in an enlarged form. The circuit board 34 includes at least one land portion 341. Each land portion 341 is a portion of the circuit board 34 where a copper foil is exposed. Each land portion 341 is arranged on a lower surface of the circuit board and radially inward of an outer circumferential surface of the flat plate portion 332. In the present preferred embodiment, four of such land portions 341 are preferably arranged on the lower surface of the circuit board 34. In addition, the flat plate portion 332 includes four through holes 333. Each of the conducting wires 3221 is preferably drawn out through a separate one of the through holes 333. Each conducting wire 3221 is connected to a corresponding one of the land portions 341 through, for example, a solder (e.g., a lead solder, a lead-free solder, etc.) or the like. The circuit board 34 and the motor 1 are thus electrically connected to each other. Drive currents for the motor 1 are supplied from the external power supply to the coils 322 through the circuit board 34. A torque is produced between the armature 32 and the rotor magnet 23 as a result of supply of the drive currents to the coils 322.

In the present preferred embodiment, each land portion 341 is preferably arranged under a corresponding one of the through holes 333. Note, however, that the position of each land portion 341 is not limited to the above. For example, each land portion 341 may be arranged radially outward of the corresponding one of the through holes 333.

Note that the number of through holes 333 is not limited to four, but may alternatively be any of one, two, three, or more than four. For example, all the conducting wires 3221 may be drawn out through a single through hole 333. Also, two or more of the conducting wires 3221 may be drawn out through each of two or more of the through holes 333. Also, the through holes 333 may include a through hole through which no conducting wire 3221 is drawn out.

One preferable example of the circuit board 34 is a flexible printed circuit board. Use of the flexible printed circuit board prevents an increase in the axial thickness of the circuit board 34 compared to the case where another type of circuit board is used. This in turn prevents an increase in the axial dimension of the motor 1.

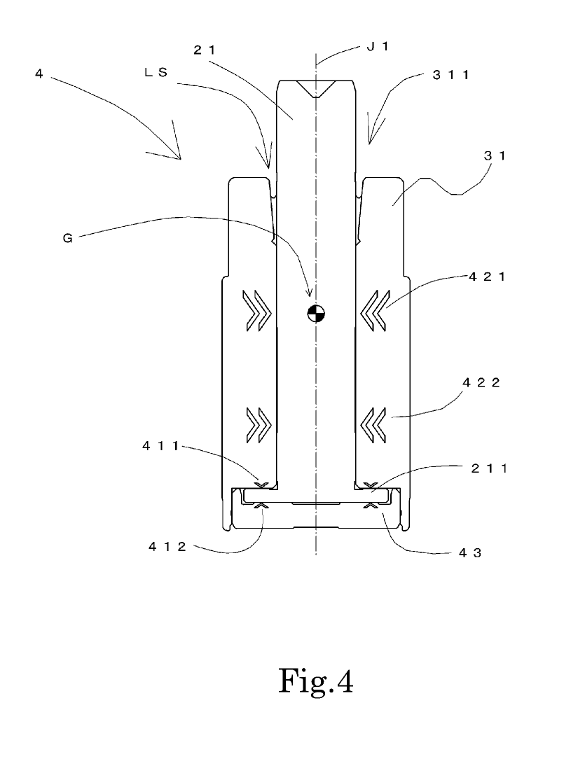

Next, the structure of a bearing apparatus included in the motor 1 will now be described below. FIG. 4 is a cross-sectional view of a bearing used in the motor 1. The shaft 21 is accommodated in the bearing hole 311 of the sleeve 31. An upper opening portion of the bearing hole 311 is preferably arranged to have a diameter gradually increasing with increasing height. In other words, an inner circumferential surface of the upper opening portion of the bearing hole 331 is an inclined surface which is inclined radially outward with increasing height.

A cap 43 is preferably arranged on a lower portion of the sleeve 31. More specifically, the cap 43 is arranged at a lower opening portion of the bearing hole 311. The lower opening portion of the bearing hole 311 is closed by the cap 43. The cap is preferably fixed to the lower portion of the sleeve 31 through, for example, press fitting, adhesion, crimping, welding, or the like.

A lubricating fluid is arranged between an outer circumferential surface of the shaft 21 and an inner circumferential surface of the sleeve 31. For example, a polyolester oil, a diester oil, or the like is preferably used as the lubricating fluid. The lubricating fluid has a liquid surface LS. The liquid surface LS of the lubricating fluid is arranged between the shaft 21 and the sleeve 31. More specifically, the liquid surface LS of the lubricating fluid is arranged between the outer circumferential surface of the shaft 21 and the inclined surface of the bearing hole 311. The shaft 21, the sleeve 31, and the lubricating fluid are arranged to together define the bearing apparatus of the motor 1. The bearing apparatus of the motor 1 will be hereinafter referred to as a fluid dynamic bearing apparatus 4, because the lubricating fluid is used therein. The shaft 21 is supported through the lubricating fluid to be rotatable with respect to the sleeve 31. The rotating portion 2 is supported by the fluid dynamic bearing apparatus 4 to be rotatable with respect to the stationary portion 3.

That is, in the present preferred embodiment, the shaft 21, which is a component of the rotating portion 2, is supported through the lubricating fluid to be rotatable with respect to the sleeve 31, which is a component of the stationary portion 3.

The fluid dynamic bearing apparatus 4 will now be described in detail below. At least one of the outer circumferential surface of the shaft 21 and the inner circumferential surface of the sleeve 31 includes a plurality of radial dynamic pressure groove arrays. More specifically, at least one of the outer circumferential surface of the shaft 21 and the inner circumferential surface of the sleeve 31 includes an upper radial dynamic pressure groove array 421 and a lower radial dynamic pressure groove array 422. Referring to FIG. 1, in the present preferred embodiment, the inner circumferential surface of the sleeve 31 includes the upper and lower radial dynamic pressure groove arrays 421 and 422. The lower radial dynamic pressure groove array 422 is arranged below the upper radial dynamic pressure groove array 421. Note that the upper and lower radial dynamic pressure groove arrays 421 and 422 may be defined in the outer circumferential surface of the shaft 21 instead of the inner circumferential surface of the sleeve 31.

Each of the radial dynamic pressure groove arrays is preferably arranged to generate a dynamic pressure in the lubricating fluid. More specifically, each of the upper and lower radial dynamic pressure groove arrays 421 and 422 is arranged to generate a dynamic pressure in the lubricating fluid. As illustrated in FIG. 4, each of the upper and lower radial dynamic pressure groove arrays 421 and 422 is arranged in a herringbone pattern. The rotating portion 2 is arranged to rotate in one direction with respect to the stationary portion 3 while the motor 1 is running. The upper and lower radial dynamic pressure groove arrays 421 and 422 are arranged to draw in portions of the lubricating fluid which are present between the shaft 21 and the sleeve 31 toward middles of the upper and lower radial dynamic pressure groove arrays 421 and 422, respectively, at this time. This arrangement enables the shaft 21 to be supported radially with respect to the sleeve 31.

In the fluid dynamic bearing apparatus 4 illustrated in FIG. 4, the shaft 21 preferably includes a thrust plate portion 211. The thrust plate portion 211 is in the shape of a disk, and is arranged to extend radially outward from a lower portion of the shaft 21. In the present preferred embodiment, the shaft 21 and the thrust plate portion 211 are defined by a single monolithic member. Note, however, that this is not essential to the present invention such that the shaft 21 and the thrust plate portion 211 may be defined by separate members if so desired. In this case, the thrust plate portion 211 is fixed to the lower portion of the shaft 21 through, for example, press fitting, adhesion, crimping, or the like.

An upper surface of the thrust plate portion 211 is arranged axially opposite a lower surface of the sleeve 31 with an upper thrust gap intervening therebetween. At least one of the upper surface of the thrust plate portion 211 and the lower surface of the sleeve 31 includes an upper thrust dynamic pressure groove array 411. In FIG. 4, the upper thrust dynamic pressure groove array 411 is defined in the lower surface of the sleeve 31. Note, however, that this is not essential to the present invention. Instead, the upper thrust dynamic pressure groove array 411 may be defined in the upper surface of the thrust plate portion 211.

A lower surface of the thrust plate portion 211 is preferably arranged axially opposite an upper surface of the cap 43 with a lower thrust gap intervening therebetween. At least one of the lower surface of the thrust plate portion 211 and the upper surface of the cap 43 includes a lower thrust dynamic pressure groove array 412. In FIG. 4, the lower thrust dynamic pressure groove array 412 is defined in the upper surface of the cap 43. Note, however, that this is not essential to the present invention. Instead, the lower thrust dynamic pressure groove array 412 may be defined in the lower surface of the thrust plate portion 211.

Each of the upper and lower thrust dynamic pressure groove arrays 411 and 412 may be arranged in either a herringbone pattern or a spiral pattern. The rotating portion 2 is arranged to rotate in one direction with respect to the stationary portion 3 while the motor 1 is running. The upper thrust dynamic pressure groove array 411 is arranged to draw a portion of the lubricating fluid which is present between the thrust plate portion 211 and the lower surface of the sleeve 31 radially inward at this time. Meanwhile, the lower thrust dynamic pressure groove array 412 is arranged to draw a portion of the lubricating fluid which is present between the thrust plate portion 211 and the upper surface of the cap 43 radially inward. These arrangements enable the shaft 21 to be supported axially with respect to the sleeve 31.

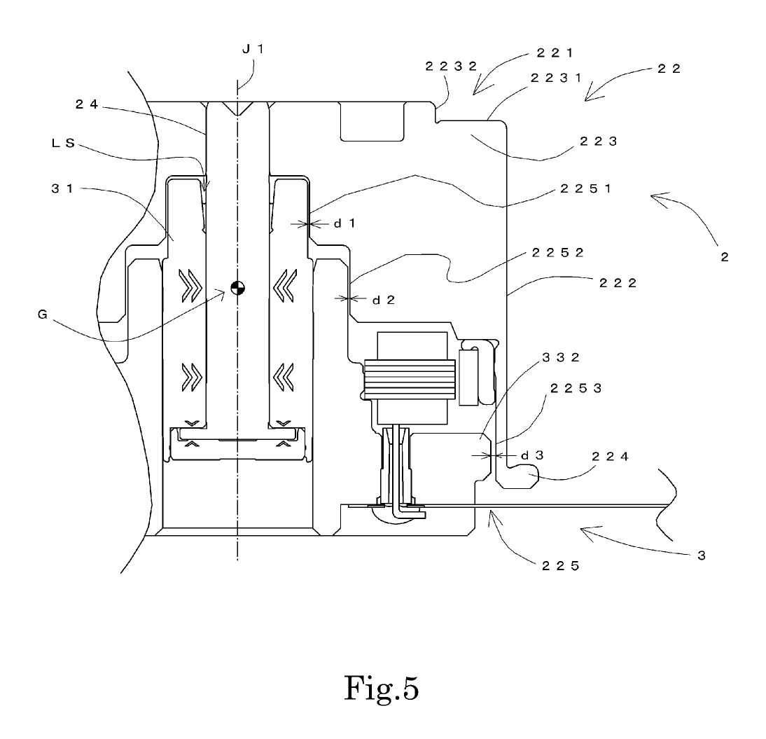

FIG. 5 is a diagram illustrating a portion of the motor 1 in an enlarged form. Referring to FIG. 5, in the present preferred embodiment, the lower disk mounting portion 224 is arranged at a level lower than a level of the lower radial dynamic pressure groove array 422. In addition, the axial position of the center G of gravity of the rotating portion 2 is arranged above that of the lower radial dynamic pressure groove array 422. These arrangements improve stability of rotation of the rotating portion 2, and reduce vibrations during the rotation thereof. That is, in the case where a disk, such as, for example, a color wheel, is mounted on at least one of the upper and lower disk mounting portions 223 and 224 of the motor 1, highly accurate rotation of the disk is achieved.

In the present preferred embodiment, the fluid dynamic bearing apparatus 4 is used as the bearing apparatus. In the fluid dynamic bearing apparatus 4, the shaft 21 is arranged to rotate with respect to the sleeve 31 through the lubricating fluid. Meanwhile, in the case of a ball bearing or a sleeve bearing, components of the bearing apparatus are arranged to rotate relative to each other while being in sliding contact with each other. Therefore, the fluid dynamic bearing apparatus 4 is more resistant to wear than the ball bearing or the sleeve bearing. Thus, the motor 1 is able to rotate with high accuracy for a longer period of time than a conventional motor designed to rotate the color wheel.

Moreover, when the fluid dynamic bearing apparatus 4 is used in the motor designed to rotate the color wheel, the motor is able to bear a heavier load than the conventional motor designed to rotate the color wheel. The motor therefore allows a plurality of disks mounted thereon.

The axial position of the center G of gravity of the rotating portion 2 is more preferably arranged to overlap with the axial position of the upper radial dynamic pressure groove array 421. This arrangement allows the center G of gravity of the rotating portion 2 to be supported at a position where the dynamic pressure is generated. That is, the above arrangement makes it possible to more stably support the rotating portion 2 such that the rotating portion 2 is rotatable with respect to the stationary portion 3. A reduction in vibrations caused by the mounting of the plurality of disks during the rotation is thus achieved. Moreover, even when an impact is applied to the motor 1 from a radial direction, the rotating portion 2 is prevented from striking against the stationary portion 3 to cause damage to the fluid dynamic bearing apparatus 4.

Furthermore, in the motor 1, the lower radial dynamic pressure groove array 422 is more preferably arranged to have an axial dimension smaller than that of the upper radial dynamic pressure groove array 421. This arrangement causes the dynamic pressure generated by the lower radial dynamic pressure groove array 422 to be smaller than the dynamic pressure generated by the upper radial dynamic pressure groove array 421. This results in a reduction in a loss of the entire fluid dynamic bearing apparatus 4 without impairing stability of the rotation.

Furthermore, referring to FIG. 5, the axial position of the upper disk mounting portion 223 is arranged to radially overlap with the axial position of the junction 24. This arrangement allows the upper and lower disk mounting portions 223 and 224 to be spaced away from each other in the axial direction. Accordingly, in the case where the disks are mounted on the upper and lower disk mounting portions 223 and 224, respectively, the disks are spaced away from each other in the axial direction. This enables stable arrangement of the disks even when the plurality of disks are mounted on the motor 1.

The rotor hub 22 will now be described in detail below. The rotor hub 22 preferably includes a recessed portion 225 having a downward opening. The recessed portion 225 and the central axis J1 are arranged to be coaxial or substantially coaxial with each other. An inner circumferential surface of the recessed portion 225 includes a first inner circumferential surface 2251, a second inner circumferential surface 2252, and a third inner circumferential surface 2253. Each of the first, second, and third inner circumferential surfaces 2251, 2252, and 2253 are arranged below the top plate portion 221 and radially inside the cylindrical portion 222. Each of the first, second, and third inner circumferential surfaces 2251, 2252, and 2253 are an annular surface. The first inner circumferential surface 2251 is arranged to have a diameter smaller than a diameter of the second inner circumferential surface 2252. The second inner circumferential surface 2252 is arranged to have a diameter smaller than that of the third inner circumferential surface 2253. In other words, the diameter of the third inner circumferential surface 2253 is preferably the greatest, followed by the diameter of the second inner circumferential surface 2252 and the diameter of the first inner circumferential surface 2251 in the order named. In addition, the first inner circumferential surface 2251 is arranged above the second inner circumferential surface 2252. The second inner circumferential surface 2252 is arranged above the third inner circumferential surface 2253. In other words, the first inner circumferential surface 2251 is arranged highest, followed by the second inner circumferential surface 2252 and the third inner circumferential surface 2253 in the order named.

The first inner circumferential surface 2251 is arranged opposite to an outer circumferential surface of the sleeve 31 with a minute gap intervening therebetween. The minute gap between the first inner circumferential surface 2251 and the outer circumferential surface of the sleeve 31 will be hereinafter referred to as a “first minute gap d1”. The second inner circumferential surface 2252 is arranged opposite to an outer circumferential surface of the bearing holding portion 331 with a minute gap intervening therebetween. The minute gap between the second inner circumferential surface 2252 and the outer circumferential surface of the bearing holding portion 331 will be hereinafter referred to as a “second minute gap d2”. Each of the first and second minute gaps d1 and d2 is arranged radially outward of the liquid surface LS of the lubricating fluid. In other words, the liquid surface LS of the lubricating fluid, the first minute gap d1, and the second minute gap d2 are arranged in the order named from radially inward to radially outward.

The first minute gap d1 is arranged to have a small radial width and a long path. This reduces the likelihood that any gas generated by evaporation of the lubricating fluid through the liquid surface LS will pass through the first minute gap d1 to travel out of the first minute gap d1. Similarly, the second minute gap d2 is arranged to have a small radial width and a long path. This reduces the likelihood that any gas generated by the evaporation of the lubricating fluid through the liquid surface LS will pass through the second minute gap d2 to travel out of the second minute gap d2. The first and second minute gaps d1 and d2 are provided in the motor 1. The provision of these minute gaps reduces the likelihood that any gas generated by the evaporation of the lubricating fluid through the liquid surface LS will travel out of the motor 1, and thus reduces the evaporation of the lubricating fluid.

Furthermore, the third inner circumferential surface 2253 is arranged opposite to the outer circumferential surface of the flat plate portion 332 with a minute gap intervening therebetween. The minute gap between the third inner circumferential surface 2253 and the outer circumferential surface of the flat plate portion 332 will be hereinafter referred to as a “third minute gap d3”. The third minute gap d3 is arranged to have a small radial width and a long path. This reduces the likelihood that any gas generated by the evaporation of the lubricating fluid through the liquid surface LS will pass through the third minute gap d3 to travel out of the third minute gap d3. Provision of the third minute gap d3 in addition to the first and second minute gaps d1 and d2 further reduces the likelihood that any gas generated by the evaporation of the lubricating fluid through the liquid surface LS will travel out of the motor 1, and thus further reduces the evaporation of the lubricating fluid.

Furthermore, the first minute gap d1 is arranged to have a width smaller than that of the second minute gap d2. This contributes to more securely preventing the evaporation of the lubricating fluid, and enables the rotating portion 2 and the stationary portion 3 to be fitted to each other with high precision.

Furthermore, the second minute gap d2 is arranged to have a width smaller than that of the third minute gap d3. This contributes to improving an effect of preventing the evaporation of the lubricating fluid, and enables the rotating portion 2 and the stationary portion 3 to be fitted to each other with high precision.

Note that the detailed shape of any member may be different from the shape thereof as illustrated in the accompanying drawings of the present application. Also note that features of the above-described preferred embodiments and the modifications thereof may be combined appropriately as long as no conflict arises.

For example, instead of the flexible printed circuit board, a rigid board or the like may alternatively be used as the circuit board 34.

Although the shaft 21 and the rotor hub 22 are defined by separate members in the present preferred embodiment, the shaft 21 and the rotor hub 22 may alternatively be defined by a single monolithic member.

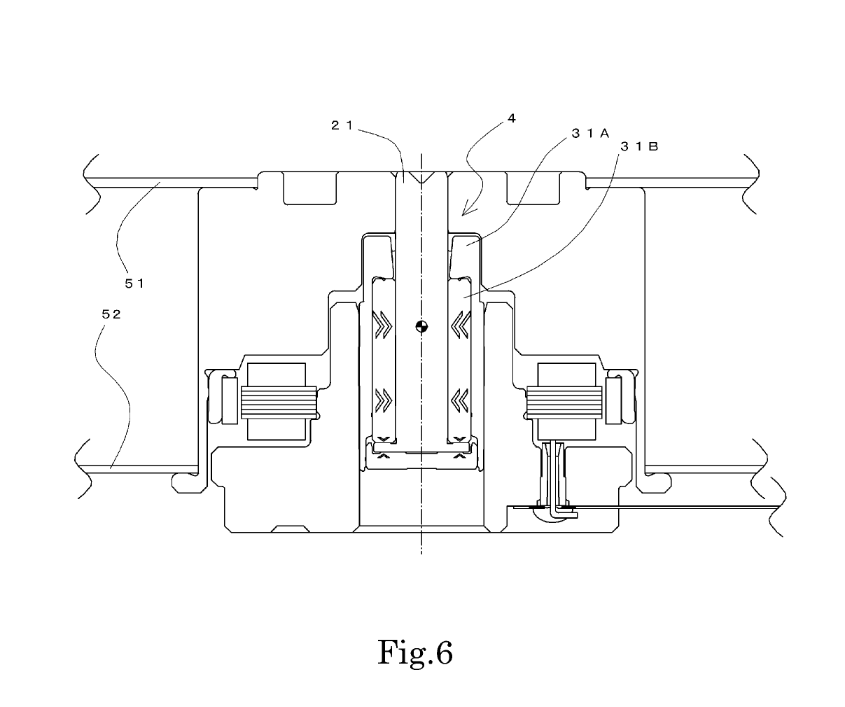

Referring to FIG. 6, a fluid dynamic bearing apparatus 4 according to a modification of the above-described preferred embodiment may be defined by the shaft 21, a sleeve 31A, a sleeve housing 31B, and the lubricating fluid.

The motor 1 according to the above-described preferred embodiment preferably is a so-called shaft-rotating motor in which the sleeve belongs to the stationary portion and the shaft belongs to the rotating portion. Note, however, that a motor according to a preferred embodiment of the present invention may be a fixed-shaft motor in which the shaft belongs to the stationary portion and the sleeve belongs to the rotating portion.

Although two disks are mounted on the motor illustrated in FIG. 1, this is not essential to the present invention. For example, three or more than three disks may be mounted on motors according to other preferred embodiments of the present invention. In the case of a preferred embodiment in which three disks are mounted on a motor, a third disk is preferably arranged between the upper and lower disks 51 and 52.

Motors according to preferred embodiments of the present invention and modifications thereof are applicable to a variety of types of disk drive apparatuses, including disk drive apparatuses arranged to rotate disks other than color wheels, such as, for example, magnetic disks or optical disks.

Motors according to preferred embodiments of the present invention and modifications thereof are usable as motors for use in disk drive apparatuses, and also as motors for applications other than the disk drive apparatuses.

Features of the above-described preferred embodiments and the modifications thereof may be combined appropriately as long as no conflict arises.

While preferred embodiments of the present invention and modifications thereof have been described above, it is to be understood that variations and modifications will be apparent to those skilled in the art without departing from the scope and spirit of the present invention. The scope of the present invention, therefore, is to be determined solely by the following claims.

1. (canceled)

2. A motor unit arranged to rotate a plurality of disks about a central axis extending in a vertical direction, the motor unit comprising.
a rotating portion arranged to rotate about the central axis; and
a stationary portion arranged to support the rotating portion; wherein
the rotating portion includes.
a shaft;
a rotor hub including a top plate portion that is disk-shaped or substantially disk-shaped and arranged to extend radially outward from an upper portion of the shaft, and a cylindrical portion that is cylindrical or substantially cylindrical and arranged to extend in an axial direction from an outer edge portion of the top plate portion; and
a rotor magnet arranged on the rotor hub;
the stationary portion includes.
a cylindrical or substantially cylindrical sleeve including a bearing hole; and
an armature arranged radially opposite the rotor magnet;
the shaft is accommodated in the bearing hole;
a lubricating fluid is arranged between an outer circumferential surface of the shaft and an inner circumferential surface of the sleeve;
at least one of the outer circumferential surface of the shaft and the inner circumferential surface of the sleeve includes.
an upper radial dynamic pressure groove array arranged to generate a dynamic pressure in the lubricating fluid; and
a lower radial dynamic pressure groove array arranged below the upper radial dynamic pressure groove array, and arranged to generate a dynamic pressure in the lubricating fluid;
the rotor hub includes an upper disk mounting portion and a lower disk mounting portion arranged axially below the upper disk mounting portion;
the lower disk mounting portion is arranged at a level lower than a level of the lower radial dynamic pressure groove array; and
an axial position of a center of gravity of the rotating portion is arranged above an axial position of the lower radial dynamic pressure groove array.

3. The motor unit according to claim 2, wherein the axial position of the center of gravity of the rotating portion is arranged to overlap with an axial position of the upper radial dynamic pressure groove array.

4. The motor unit according to claim 2, wherein
the upper disk mounting portion includes an annular surface that is annular or substantially annular and arranged at an outer edge of the top plate portion, and a cylindrical surface arranged radially inward of the annular surface; and
an axial position of the upper disk mounting portion is arranged to radially overlap with an axial position of a junction of the shaft and the rotor hub.

5. The motor unit according to claim 4, wherein the cylindrical surface of the upper disk mounting portion is arranged to have a diameter smaller than an outside diameter of the cylindrical portion.

6. The motor unit according to claim 2, wherein the lower radial dynamic pressure groove array is arranged to have an axial dimension smaller than that of the upper radial dynamic pressure groove array.

7. The motor unit according to claim 2, wherein
the stationary portion further includes a base portion including a bearing holding portion arranged to hold the sleeve;
the rotor hub includes a recessed portion including a downward opening, and arranged to be coaxial with the central axis;
an inner circumferential surface of the recessed portion includes.
a first inner circumferential surface arranged opposite to an outer circumferential surface of the sleeve with a first minute gap intervening therebetween; and
a second inner circumferential surface arranged radially outward of the first inner circumferential surface, and arranged opposite to an outer circumferential surface of the bearing holding portion with a second minute gap intervening therebetween;
a liquid surface of the lubricating fluid is arranged between the shaft and the sleeve; and
the liquid surface of the lubricating fluid, the first minute gap, and the second minute gap are arranged consecutively in order from radially inward to radially outward.

8. The motor unit according to claim 7, wherein
the base portion further includes a flat plate portion arranged to extend radially outward from a lower portion of the bearing holding portion; and
the recessed portion of the rotor hub further includes a third inner circumferential surface arranged opposite to an outer circumferential surface of the flat plate portion with a third minute gap intervening therebetween.

9. The motor unit according to claim 7, wherein the first minute gap is arranged to have a width smaller than that of the second minute gap.

10. The motor unit according to claim 8, wherein
the first minute gap is arranged to have a width smaller than that of the second minute gap; and
the second minute gap is arranged to have a width smaller than that of the third minute gap.

11. A disk drive apparatus comprising.
the motor unit of claim 2; and
a circuit board arranged on the stationary portion, and electrically connected to the motor unit.

12. A spindle motor comprising.
a rotating portion arranged to rotate about a central axis extending in a vertical direction; and
a stationary portion arranged to support the rotating portion; wherein
the rotating portion includes.
a shaft;
a rotor hub including a top plate portion that is disk-shaped or substantially disk-shaped and arranged to extend radially outward from an upper portion of the shaft, and a cylindrical portion that is cylindrical or substantially cylindrical and arranged to extend in an axial direction from an outer edge portion of the top plate portion; and
a rotor magnet arranged on the rotor hub;
the stationary portion includes.
a cylindrical or substantially cylindrical sleeve including a bearing hole;
an armature arranged radially opposite the rotor magnet; and
a base portion including a bearing holding portion arranged to hold the sleeve;
the rotor hub includes a recessed portion including a downward opening, and arranged to be coaxial or substantially coaxial with the central axis;
an inner circumferential surface of the recessed portion includes.
a first inner circumferential surface arranged opposite to an outer circumferential surface of the sleeve with a first minute gap intervening therebetween; and
a second inner circumferential surface arranged radially outward of the first inner circumferential surface, and arranged opposite to an outer circumferential surface of the bearing holding portion with a second minute gap intervening therebetween;
the shaft is accommodated in the bearing hole;
a lubricating fluid is arranged between an outer circumferential surface of the shaft and an inner circumferential surface of the sleeve;
a liquid surface of the lubricating fluid is arranged between the shaft and the sleeve;
at least one of the outer circumferential surface of the shaft and the inner circumferential surface of the sleeve includes a plurality of radial dynamic pressure groove arrays each of which is arranged to generate a dynamic pressure in the lubricating fluid; and
the liquid surface of the lubricating fluid, the first minute gap, and the second minute gap are arranged consecutively in order from radially inward to radially outward.

13. The spindle motor according to claim 12, wherein
the base portion further includes a flat plate portion arranged to extend radially outward from a lower portion of the bearing holding portion; and
the recessed portion of the rotor hub further includes a third inner circumferential surface arranged opposite to an outer circumferential surface of the flat plate portion with a third minute gap intervening therebetween.

14. The spindle motor according to claim 12, wherein the first minute gap is arranged to have a width smaller than that of the second minute gap.

15. The spindle motor according to claim 13, wherein
the first minute gap is arranged to have a width smaller than that of the second minute gap; and
the second minute gap is arranged to have a width smaller than that of the third minute gap.

16. The spindle motor according to claim 12, wherein
the plurality of radial dynamic pressure groove arrays include.
an upper radial dynamic pressure groove array; and
a lower radial dynamic pressure groove array arranged below the upper radial dynamic pressure groove array; and
the lower radial dynamic pressure groove array is arranged to have an axial dimension smaller than that of the upper radial dynamic pressure groove array.

17. A motor unit comprising.
the spindle motor of claim 12;
at least two disks mounted on the rotor hub; and
a circuit board arranged on a lower surface of the base portion, and electrically connected to the spindle motor.
